(19) United States
(12) Patent Application Publication
(10) Pub. No.: US 2011/0016793 A1
(43) Pub. Date: Jan. 27, 2011

(54) CABLE WINDING DRUM, WINDOW REGULATOR AND BODYWORK ELEMENT

(76) Inventors: Christophe Gallois, Chateauneuf Sur Loire (FR); Cyril Decherf, Polly-Lez-Gien (FR)

Correspondence Address: CARLSON, GASKEY & OLDS, P.C., 400 WEST MAPLE ROAD, SUITE 350, BIRMINGHAM, MI, 48009, US

(21) Appl. No.: 12/691,896

(22) Filed: Jan. 22, 2010

(30) Foreign Application Priority Data
Jan. 26, 2009 (FR) 0900328

(51) Int. Cl. E05F 11/48; E06B 7/16; B66D 1/30; B66D 1/36

(52) U.S. Cl. 49/352; 254/278

(57) ABSTRACT

A cable winding drum includes tracks for the winding of a plurality of cable runs, each of the tracks having a winding diameter whose diameter varies. A window regulator and a bodywork element are also included. A window driven by the window regulator having the drum moves at different speeds depending on the winding configuration of the cable around the drum.

### REFERENCE TO RELATED APPLICATION

This application claims priority to French Patent Application No. FR 0900328 filed Jan. 26, 2009.

### BACKGROUND OF THE INVENTION

The present invention relates to a cable winding drum, a window regulator with the cable winding drum, and a bodywork element with the window regulator.

A window regulator drives a window between a lowered position (in which the window is at least partially inside a door or a side of a vehicle) and a raised position (in which the window compresses a roof seal or a top seal of a frame of a door, hereinafter a “roof seal” for simplicity). The window regulator can drive the window via a cable, which in turn is driven by a cable winding drum. The drum is turned by a geared motor. The drum has a constant diameter, so the speed of the window is constant between the raised position and the lowered position. In particular, the window arrives at the raised position at the same speed as during the rest of the path. The geared motor is designed to allow the window to reach the raised position in which the window compresses the roof seal in such a way as to create a good seal. The geared motor is therefore oversized for the rest of the path of the window. This can expensive and can potentially pinch a user or a foreign body.

There is therefore a need to reduce the cost and the closing power without reducing the closing force in the region of the roof seal.

### SUMMARY OF THE INVENTION

For this purpose, a cable winding drum includes tracks for the winding of a plurality of cable runs, each of the tracks having a winding diameter whose diameter varies. In a variant, the turns of one track alternate with the turns of another track. In a variant, the variation of the diameter of the tracks is not in phase or is of a different profile between two tracks. In a variant, the variations of the diameter of the tracks are in phase.

In a variant, each track includes at least a first section with a first winding diameter, a second section with a second winding diameter, the second diameter being smaller than the first diameter, and a third section with a diameter that is variable between the first diameter and the second diameter.

In a variant, the drum includes housings for securing the ends of a cable, the housings being at opposite ends of the tracks. The invention also relates to a window regulator includes a cable winding drum as described above. In a variant, the window regulator further includes a cable driven by the drum, the cable including a first run that winds in one direction onto one track of the drum and a second run that winds in another direction onto another track of the drum.

The invention also relates to a bodywork element including the window regulator as described above, a window driven by the window regulator between a raised position and a lowered position, and a seal compressed by the window in its raised position.

In a variant, a cable run of the window regulator winds around a section of the drum that has the smallest diameter when the window is in a predetermined upper region containing the seal between the lowered position and the raised position. In a variant, the cable run winds around the smallest-diameter section when a top edge of the window is at least 2.5 centimeters away from the raised position.

### BRIEF DESCRIPTION OF THE DRAWINGS

Other features and advantages of the invention will become apparent on reading the following detailed description of various embodiments of the invention, given by way of example only and with reference to the drawings, which show:

FIG. 1 illustrates a schematic view of a bodywork element; and

FIGS. 2 to 4 illustrate perspective views of a cable winding drum.

### DETAILED DESCRIPTION OF THE PREFERRED EMBODIMENT

A cable winding drum includes tracks for the winding of a plurality of cable runs, each of the tracks having a winding diameter whose diameter varies. This makes it possible, given a constant speed of rotation of the drum, to generate a cable winding speed that differs according to the winding diameter. Consequently, a window driven by a window regulator having such a drum has a speed of displacement that varies depending on the state of winding of the cable around the drum. It also makes it possible to reduce the cost and the closing power without reducing the closing force in the region of a roof seal.

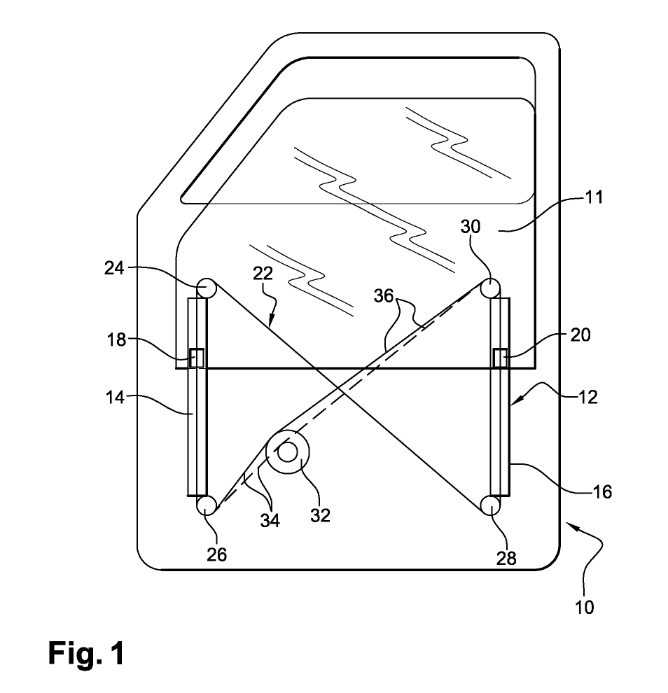

FIG. 1 shows a schematic view of a bodywork element 10 (such as a motor vehicle door) in which a window regulator 12 is mounted. The window regulator 12 drives a window 11. The window 11 is driven between a lowered position, in which the window 11 is at least partially inside the bodywork element 10, and a raised position, in which the window 11 passes into a seal at the top of a window frame or into a roof seal if the vehicle has doors without frames.

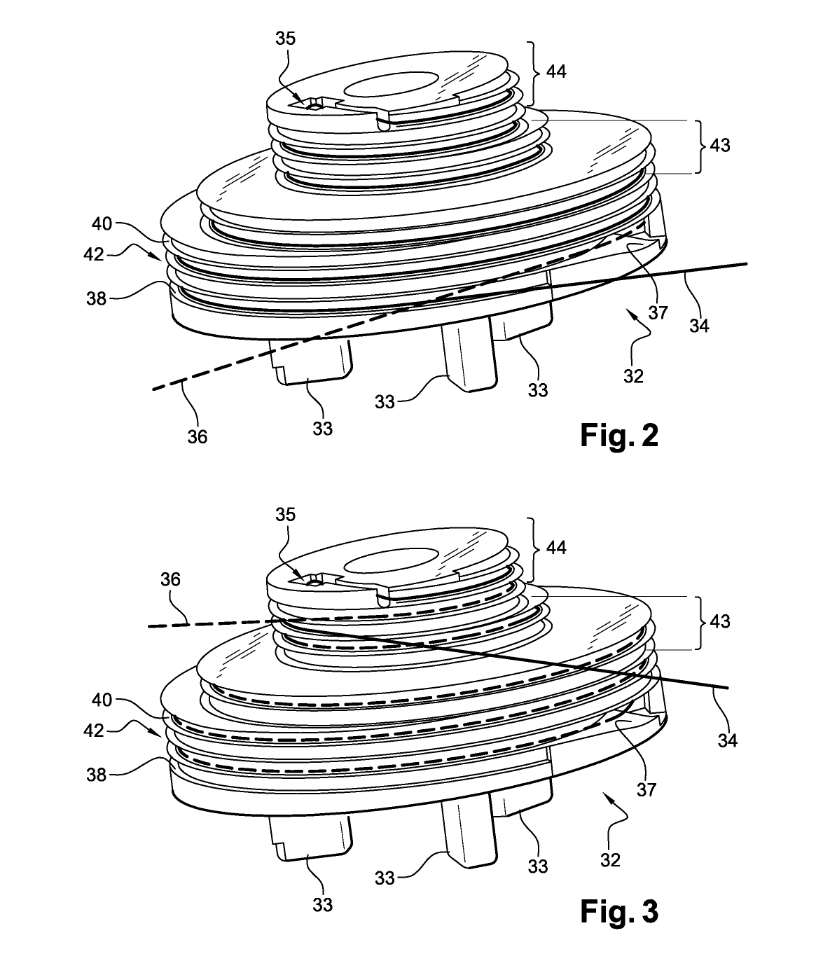

The window regulator 12 shown in FIG. 1 is a window regulator 12 with two rails 14 and 16, by way of example. The window regulator 12 may have only one rail, the other rail being absent. The illustrated window regulator 12 includes two rails 14 and 16 with a slider 18 and 20 travelling on each rail 14 and 16, respectively. The sliders 18 and 20 are fixed to the window 11 and driven by a cable 22. The cable 22 follows an X-shaped path between deflectors 24, 26, 28 and 30, which may be pulleys, for example. The cable 22 is driven by a drum 32 around which the cable 22 winds and unwinds. The drum 32 is turned by a geared motor (not shown). In FIGS. 2 and 3, which are perspective views of the drum 32, the drum 32 has legs 33 which engage with a toothed wheel. The toothed wheel meshes via its teeth with a worm turned by the geared motor itself.

The cable 22 includes a first run 34 and a second run 36. The runs 34 and 36 are wound in opposite directions around the drum 32. As one run is being wound onto the drum 32, the other run is unwinding. This enables the sliders 18 and 20 to move upward and downward inside the bodywork element. The run winding onto the drum 32 is considered to be the run which is driving the window 11. For example, when the run 34 is being wound onto the drum 32, the other run 36 is unwinding, allowing the sliders 18 and 20 to descend and carry the window 11 to the lowered position. Reversing the winding and unwinding of the runs 34 and 26 moves the window 11 toward the raised position. In FIGS. 2 and 3, the end of the run 34 (in solid line) is secured by way of example by a dowel to the drum 32 in the housing 35. The end of the run 36 (in dashes) is secured by way of example by a dowel to the drum 32 in a housing 37 at the opposite end of the tracks 38 and 40 from the housing 35. Thus, beginning with the drum 32 in a position (FIG. 3) in which the run 36 is wound around the drum 32 and the run 34 is essentially unwound from the drum 32, clockwise rotation of the drum 32 gradually winds the run 34 and unwinds the run 36 until the position shown in FIG. 2 is reached.

In FIG. 1, the runs 34 and 36 are indicated in solid line to represent the situation in FIG. 2, and in dashes to represent the situation in FIG. 3.

FIGS. 2 and 3 are perspective views of the drum 32. The drum 32 includes a plurality of tracks for the winding of the cable 22 (or runs of cable 22) around its perimeter. The winding tracks form a helix around the perimeter of the drum 32. The winding tracks are therefore made up of turns delineating a helix around the perimeter of the drum 32. In particular, in FIGS. 2 and 3, the drum 32 has two cable winding tracks 38 and 40. Each track 38 and 40 allows the winding and unwinding, respectively, of the runs 34 and 36. While the run 34 is being wound onto the track 38, the run 36 is unwinding from the track 40.

The drum 32 includes winding tracks for a plurality of cable runs, each of the tracks having a winding diameter whose diameter varies. The drum 32 has an outside diameter that varies. This makes it possible to vary the speed at which the window 11 is driven on the basis of the position of the window 11 between the window-raised position and the window-lowered position. In particular, with the geared motor running at a constant speed, it enables the speed of the window 11 to be reduced in the vicinity of the window-raised position when a run is winding around a smaller diameter of the drum 32. Since the closing force is increasing, a less powerful geared motor connected to this drum 32 is able to properly compress the roof seal, just as a more powerful geared motor would do with a constant-diameter drum. As an example, in FIG. 1, when the run 36 is winding around the drum 32 to raise the window 11, the speed of the window 11 drops when the run 36 winds around a smaller diameter of the drum 32. To the user, the speed reduction at the end of the window-closing travel gives the impression of a gentler closing of the window 11. In addition, the reduction in the speed of the window 11 in the vicinity of the raised position makes it possible to reduce the force with which an object could be pinched between the top edge of the window 11 and the top frame of the door element or roof.

FIGS. 2 and 3 show the variation in the diameter on which the cable runs 34 and 36 are wound. The drum 32 includes sections with a winding diameter that differs from section to section. The tracks 38 and 40 include a section 42 which has the greatest winding diameter, and the tracks 38 and 40 include a section 44 which has the smallest winding diameter. The tracks 38 and 40 also include a section 43 whose diameter is variable (or progressive) between the diameters of the sections 42 and 44. The section 43 joins up the diameters of sections the 42 and 44. Other sections with a constant intermediate diameter between those of the sections 42 and 44 are possible, thus defining step changes in the speed of movement of the window 11.

The winding around the section 44 corresponds to the movement of the window 11 close to the raised position of the window 11 (the closed position). For example, when the run 36 is winding around the section 44 (FIG. 3), the run 36 drives the window 11 towards the raised position at a reduced window speed, even though the geared motor is turning at the same speed.

More specifically, when the window 11 is in the lowered position (FIG. 2), the sliders 18 and 20 are in the lowered position on the rails 14 and 16, the run 36 being essentially unwound, and the run 34 being wound up. When the drum 32 is turned by the geared motor, it winds up the run 36 around the drum 32 and unwinds the run 34. The run 36 initially winds onto the larger-diameter section 42 for most of the path of the window 11 towards the raised position. Then, when the window 11 is in a predetermined higher region containing the roof seal, between the lowered position and the raised position, the run 36 winds around the drum 32 whose diameter decreases to reduce the speed of movement of the window 11. This region may include up to the last 20 centimeters of the path of the window 11. In particular, in the vicinity of the raised position of the window 11, the run 36 winds around the section 43 of decreasing diameter, which gradually reduces the window 11 speed. The run 36 then winds around the smallest-diameter section 44 (FIG. 3), which allows the window 11 to reach the raised position at a slow speed. Thus, on approaching the raised position of the window 11, the window 11 speed decreases. Preferably, if it is wished to improve the anti-pinch function, the run 36 winds around the section 44 when the top edge of the window 11 is at least 2.5 centimeters away from the raised position.

Conversely, when the window 11 is in the raised position (FIG. 3), the sliders 18 and 20 are in the raised position on the rails 14 and 16, respectively, the run 34 being essentially unwound, and the run 36 being wound. When the drum 32 is turned clockwise by the geared motor, it winds up the run 34 around the drum 32 and unwinds the run 36. The run 34 initially winds around the smallest-diameter section 44, causing the window 11 to move at a slow speed. The run 34 then winds around the variable-diameter section 43, which increases the speed of the window. The run 34 then winds around the largest-diameter section 42 (FIG. 2) for most of the downward path of the window 11.

The electronic circuitry associated with the geared motor monitors the speed of rotation of the motor by various known means, with a motor-speed to window-speed ratio which increases on the small diameter of the drum 32, giving better definition and quicker detection of a pinch. This region is critical because small obstacles such as a finger can be trapped in this region. In addition, an obstacle such as a finger is referred to as a hard obstacle because it is not easily compressible (it is similar to a very stiff spring), and therefore the pinch force which it experiences increases very rapidly in the space of a few millimeters between the moment when the pinch begins and the moment when, after its detection, the motor actually stops and changes its direction of rotation to release it. With the smaller-diameter drum 32, for the same number of revolutions of the motor to arrive at the stop, the window 11 travels a shorter distance, and the pinch force increases less. The result is an improved anti-pinch system.

Furthermore, since the drum 32 includes tracks having a winding diameter whose diameter varies, the power and hence the cost of the geared motor can be reduced. This is because a window regulator 12 geared motor is conventionally sized to enable the window 11 to stress the seal situated in the roof or the top of the door frame as it arrives at the raised position. The seal keeps out air and water when the window 11 is in the raised position, so the seal is very stiff. The torque generated by the geared motor must therefore be great enough to stress the seal. However, during the rest of the path of the window 11, either upwards or downwards, the torque generated by the geared motor is greater than it needs to be. Using the drum 32, the force generated in the cable 22 (for more or less constant torque in the geared motor) is greater when the cable 22 is winding around the smallest-diameter section 44 than when the cable 22 is winding around the largest-diameter section 42. Thus, since it is possible to increase the force applied to the cable 22 with the smallest-diameter section 44 of the drum 32, it is possible to use a geared motor that is less powerful, but from which the torque developed is converted into an increase in the force applied to the smallest-diameter section 44.

The cable winding tracks are alternating or interleaved. In other words, the turns of one track alternate with the turns of another track. The drum 32 in FIGS. 2 and 3 includes two tracks 38 and 40, and the turns of track 38 alternate with the turns of track 40. One turn in two belongs to one of the tracks 38 and 40. This provides a way of reducing the size of the drum 32 because it avoids the use (for example, superposed) of two drums, each with a cable winding track.

In FIGS. 2 and 3, the variations of the diameters of the tracks 38 and 40 are in phase. In other words, the tracks 38 and 40 have a diameter which varies simultaneously.

Because of the variable diameter of the drum 32, the length of cable 22 in the cable pathway is variable depending on the positions of the runs 34 and 36 along the tracks 38 and 40 in the sections 42, 43 and 44. Thus, the length of the runs 34 and 36 between the drum 32 and the deflectors 26 and 30, respectively, in FIG. 1 is greater (runs in solid line) in the case of FIG. 2 (the runs are in the largest-diameter section 42) than in the case of FIG. 3 (the runs are in the smallest-diameter section 44), where the runs 34 and 36 are shown in dashes in FIG. 1. This is due to the lengthening of the distance between the deflectors 26 and 30 and the drum 32 and to the modification of the tangents to the deflectors 26 and 30 and the drum 32. Tensioners can be used to compensate for this cable length difference (especially if the variations of the track diameters are in phase).

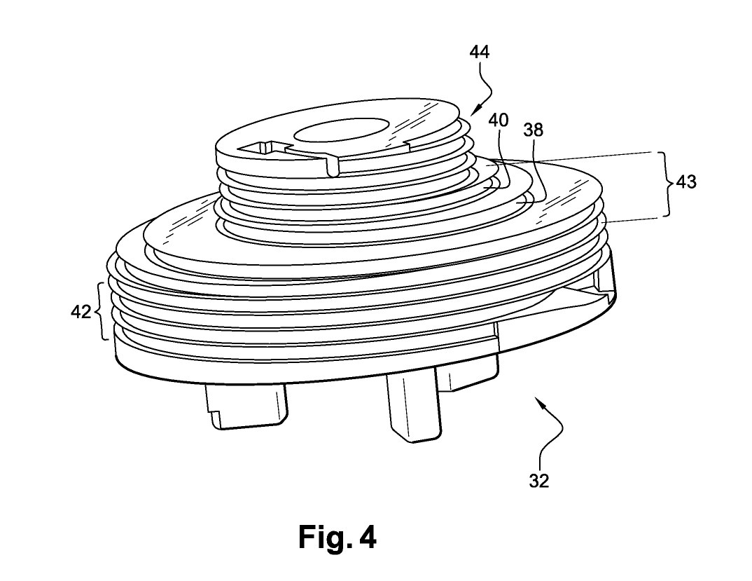

Equally (alternatively or in combination with the tensioners), the variation of the diameter of each track 38 and 40 could be out of phase and/or be of a different profile between two tracks 38 and 40. On the drum 32 in FIG. 4, the tracks 38 and 40 vary from the largest-diameter section 42 to the variable-diameter section 43 at different angles in the phase. The same is true from the section 43 to the section 44. For example, the track 38 can vary from the section 42 to the section 43 before the track 40, and similarly when changing from the section 43 to the section 44. Thus, beginning with the position shown in FIG. 2 with the run 34 wound up and the run 36 unwound, the run 34 will unwind from the section 42 to the smaller-diameter section 44 before the run 36 winds from the section 42 to the section 43. This makes it possible for the cable 22 to be wound up faster than it is unwound.

The description given above is not restricted. It is also conceivable, as an alternative or in combination, to give the drum 32 a small diameter to arrive at the lowered position of the window 11. The drum 32 may thus have a smaller-diameter section on either side of the section 42 or a smaller-diameter section on only one side of section 42.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A cable winding drum comprising:
tracks for the winding of a plurality of cable runs, each of the tracks having a winding diameter that varies.

2. The drum according to claim 1, wherein turns of one of the tracks alternate with turns of another of the tracks.

3. The drum according to claim 1, wherein a variation of the winding diameter of the tracks is not in phase or is of a different profile between the tracks.

4. The drum according to claim 1, wherein the variations of the winding diameters of the tracks are in phase.

5. The drum according to claim 1, wherein each of the tracks includes at least a first section with a first winding diameter, a second section with a second winding diameter, the second diameter being smaller than the first diameter, and a third section with a diameter that is variable between the first diameter and the second diameter.

6. The drum according to claim 1, wherein the drum includes housings for securing ends of a cable, the housings being at opposite ends of the tracks.

7. A window regulator comprising:
a cable winding drum including tracks for the winding of a plurality of cable runs, each of the tracks having a winding diameter that varies.

8. The window regulator according to claim 7, further including a cable driven by the cable winding drum, the cable including a first run that winds in one direction onto one of the tracks of the cable winding drum and a second run that winds in another direction onto another of the tracks of the cable winding drum.

9. A bodywork element comprising:
a window regulator including a cable winding drum including tracks for the winding of a plurality of cable runs, each of the tracks having a winding diameter that varies;
a window driven by the window regulator between a raised position and a lowered position; and
a seal compressed by the window in the raised position.

10. The bodywork element according to claim 9, wherein a cable run of the window regulator winds around a smallest-diameter section of the cable winding drum that has a smallest diameter when the window is in a predetermined upper region containing the seal and between the lowered position and the raised position.

11. The bodywork element according to claim 10, wherein the cable run winds around the smallest-diameter section when a top edge of the window is at least 2.5 centimeters away from the raised position.
